(19) United States
(12) Patent Application Publication
(10) Pub. No.: US 2007/0038701 A1
(43) Pub. Date: Feb. 15, 2007

(54) Conferencing system

(75) Inventors: Kenneth D. Majors, Lake Oswego, OR (US); Scott A. Deboy, Hillsboro, OR (US); Eric A. Rath, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: VirtualDesign.net, Inc.

(21) Appl. No.: 11/407,428

(22) Filed: Apr. 19, 2006

Related U.S. Application Data
(63) Continuation of application No. 11/219,502, filed on Sep. 2, 2005.
(60) Provisional application No. 60/676,089, filed on Apr. 28, 2005.

(51) Int. Cl. G06F 15/16

(52) U.S. Cl. 709/204

(57) ABSTRACT

A conferencing system includes a moderator to enable audio transmission by individual participants to improve the effectiveness of communication between remotely located conferees.

### CROSS-REFERENCE TO RELATED APPLICATIONS

This application is a continuation of U.S. patent application Ser. No. 11/219,502, filed Sep. 1, 2005 which claims the benefit of U.S. Provisional App. No. 60/676,089, filed Apr. 28, 2005.

### BACKGROUND OF THE INVENTION

The present invention relates to a conferencing system and, more particularly, to a computer-based conferencing system enabling managed communication between the conference participants.

Many business activities are performed by teams of individuals that may be widely dispersed geographically. For example, product design and manufacturing are commonly performed by teams having members who are often located in facilities spread around the globe and/or who may be in transit between locations. If a decision is to be made concerning the project it may be necessary to quickly gather input and consensus from the members of the team regardless of their physical remoteness. Modern communication technology enables individuals to communicate over long distances and from remote locations. Conferencing systems facilitate communication between a plurality of remotely located users or conferees by allowing multiple users to communicatively interconnect with each other either directly as peers or by interconnecting with a central server that is interconnected to the other participants in the conference. Computer-based conferencing systems commonly provide for audio and video input from each of the conferees. In addition, a conferencing system may provide file sharing enabling conferees to view and edit files, including engineering drawings and spreadsheets, that are part of the team's project.

One goal of a conferencing system is to connect a plurality of remotely located conferees and enable communication between the conferees as if the conferees were sitting at the same conference table. However, as the number of conference locations, sources of video, audio or other data input to the conference, increases, the ability of a group to communicate effectively in a conference decreases. For example, a separate transport stream, commonly comprising audio, video and textual data streams, is required for each conference location. The bandwidth required for a conference is a function of the number of conference locations and the bandwidth required for each location. Each user may require around 150 Kbs or more for a video stream. Hundreds of mega-bits per second may be required to transmit the data streams for a conference with a large number of conference locations, effectively precluding a video conference if there are many conference locations or if a conference location is served by limited bandwidth.

In addition, in a face-to-face conference, the conferees can assimilate a number of sensory inputs from fellow conferees and can selectively focus attention on one or more of the inputs. However, the typical computer-based conferencing interface device, for example a personal computer, is incapable of rendering more than a few transport data streams at a time. Unless a server merges the data streams originating at multiple conference locations into a single stream or switches between streams, remote participants in a conference may be unaware of inputs by other conferees. There is generally no control over communications from the several conference locations and a participant has difficulty directing his/her conference interface device to focus attention on a selected input. As a result, the conference participant's experience is often less than optimal when there are many conferees.

What is desired, therefore, is a conferencing system that enables the individual members of a large group of participants in a conference to effectively communicate and interact with other remotely located conferees.

### BRIEF DESCRIPTION OF THE DRAWINGS

FIG. 1 is a block diagram of an embodiment of a conferencing system.

FIG. 2 is a block diagram of a conferencing interface device.

FIG. 3 is a block diagram of a conferencing interface device illustrating processing of audio and video streams by a media framework.

FIG. 4 is a block diagram of a conferencing interface device illustrating recording of audio and video streams with a media framework.

FIG. 5 is a block diagram of the conferencing system illustrating user authentication by the conferencing system.

FIG. 6 is an illustration of a graphical user interface for the conferencing system.

FIG. 7 is an illustration of a graphical user interface to enable a user to arrange a conference.

FIG. 8 is a flow diagram of a process of entering and leaving a conference.

FIG. 9 is a block diagram of the conferencing system illustrating a participant's entry to a conference.

FIG. 10 is an illustration of a moderator's conference control panel.

FIG. 11 is an illustration of a conference control panel for a non-moderating conference participant.

FIG. 12 is a flow diagram of a process for a conference participant's request to transmit.

FIG. 13 is a block diagram of the conferencing system during a multiple participant conference.

### DETAILED DESCRIPTION OF PREFERRED EMBODIMENTS

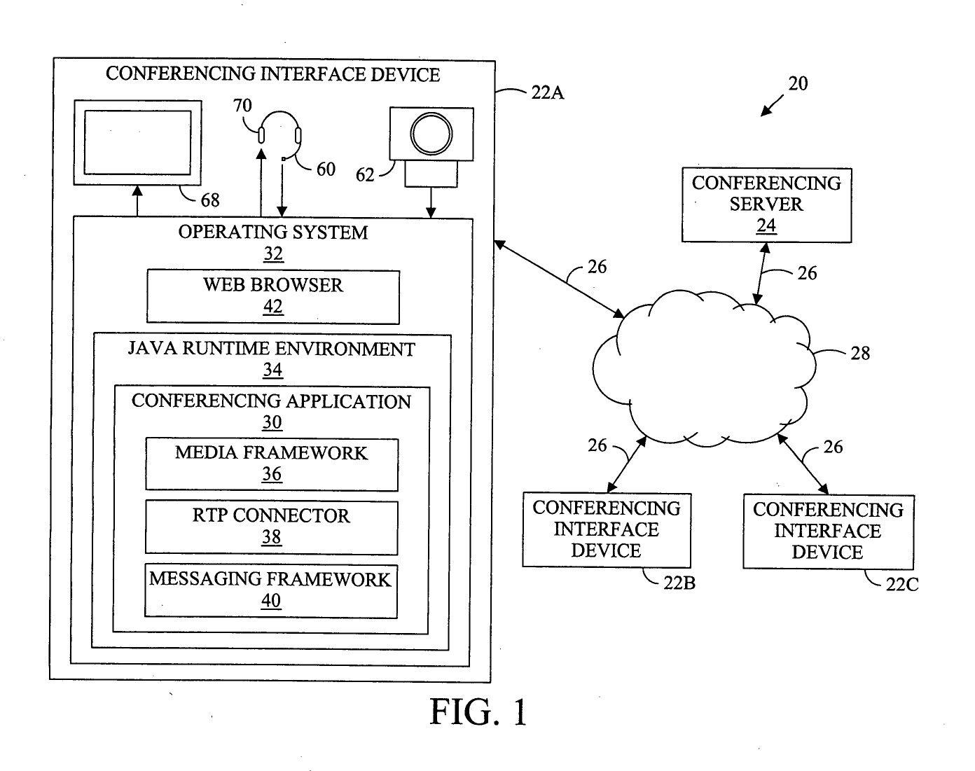

Referring in detail to the drawings where similar parts are identified by like reference numerals, and, more particularly to FIG. 1, a remote conferencing system 20 comprises a plurality of remotely located, user operated, conferencing interface devices 22a, 22b, 22c that are communicatively interconnected. A conferencing interface device is a source and/or a sink of the audio, video and/or textual data comprising a conference and represents a conference location where one or more conference participants or conferees can participate in a conference. The conferencing interface devices may be interconnected as a plurality of peers that simultaneously function as both a “client” and a “server” to the other nodes of a network of conferencing interface devices. However, the conferencing interface devices are commonly communicatively interconnected through a conferencing server 24 with the interface devices acting as clients sending requests to the server and receiving information from the server. The system may also include a peer-to-peer communication technique. Also, the system may include peer-to-peer and client-server relationships. Some arrangements may be more effective with limited bandwidth. The communication links 26 between users may comprise portions of a local area network (LAN) within a facility and/or a wide area network (WAN) that commonly includes the Internet 28, a global network of communicatively interconnected computing systems. The audio and/or video may be transmitted within the network using a multicast technique, a Unicast technique, or a UDP technique, for example.

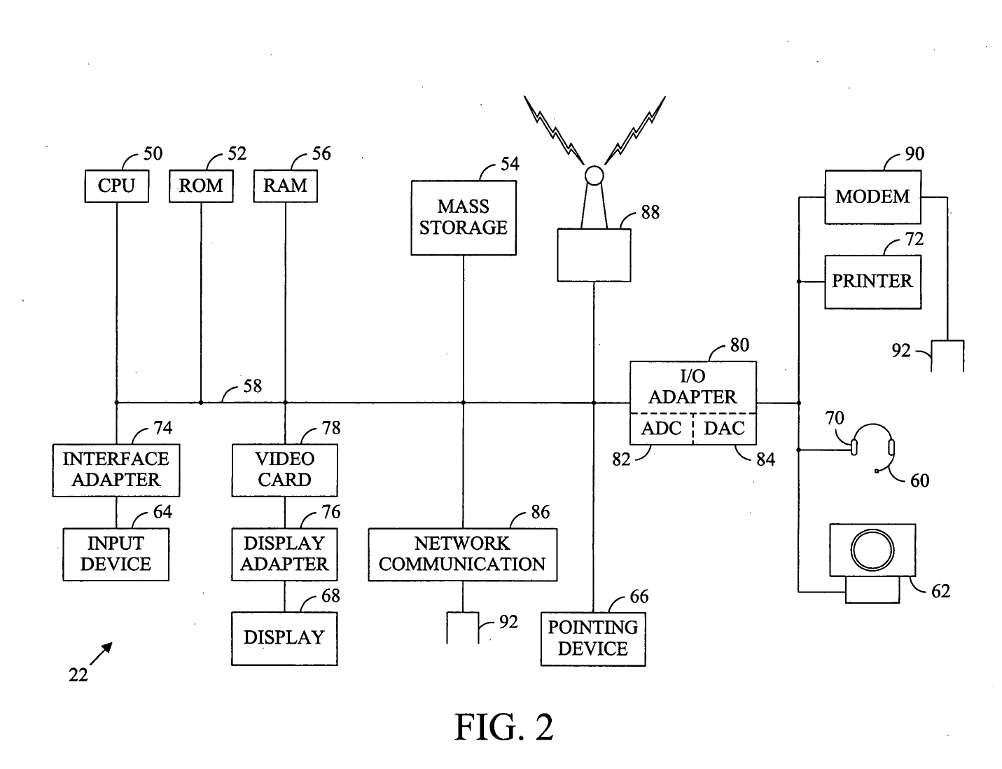

A user's interface with the conferencing system typically comprises a personal computer but may comprise other types of computing devices, such as, personal digital assistants (PDA) or mobile telephones, that are capable of connecting to and communicating over a computer network as a node or client in a peer-to-peer, server mediated or client mediated network. Referring to FIG. 2, a conferencing interface device 22 typically comprises a microprocessor-based, central processing unit (CPU) 50 that fetches data and instructions, processes the data according to the instructions, and stores or transmits the results to an output device or another data processing device. Typically, basic operating instructions used by the CPU 50 are stored in nonvolatile memory or storage, such as a flash memory or read only memory (ROM) 52. Instructions and data used by application programs, including a conferencing application program, are typically stored in a nonvolatile mass storage or memory 54, such as a disk storage unit or a flash memory. The data and instructions are typically transferred from the mass storage 54 to a random access memory (RAM) 56 and fetched from RAM by the CPU during execution. Data and instructions are typically transferred between the CPU and the mass storage over a system bus 58. It is also noted that the conferencing server 24 may include any communication technique, such as peer-to-peer, client server, Jabber, multicast, Unicast, UDP, Unicast (over TCP) and combinations thereof.

The conferencing interface device may also include a plurality of attached input/output (I/O) devices and other peripheral devices. Input devices may include an audio capture device 60, such as a microphone, a video capture device 62, such as a digital video camera, a keyboard 64 for textual input and a pointing device 66, such as a mouse, a trackball or a touch screen display. Output devices commonly include a display 68 for rendering video, text and other visual information, headphones 70 or speakers for audio output and a printer 72 or plotter to render hard copies of documents and images. Under the control of the CPU, data is transmitted to and received from each of the attached devices over a communication channel connected to the system bus 58. Typically, each device is attached to the system bus by way of an adapter, such as an interface adapter 74 providing an interface between the keyboard 64 and the system bus. Likewise, a display adapter 76 commonly provides an interface between the display 68 and a video card 78 that processes video data under the control of the CPU and is communicatively connected to the system bus. The printer 72 and similar peripheral devices are typically connected to the system bus by one or more input-output (I/O) adapters 80 commonly including an analog to digital converter (ADC) 82 and a digital to analog converter (DAC) 84.

The conferencing interface device 22 also includes communication facilities for communicatively interconnecting with other data processing devices including the conferencing server and other conferencing interface devices. These facilities may include a network interface card 86 or circuitry, and/or one or more modems 90 including ports 92 for connection to a telephone system or a wired network. In addition, the conferencing interface may be equipped with a wireless data transceiver 88 for wireless connection to the communication network. The communications facilities provide communication links 26 enabling connection to and communication with one or more computer networks such as a wide area network (WAN), commonly including the Internet, or a local area network (LAN), as appropriate at the user's location. The interface device 22 is preferably constructed in a manner that routes the packets that are received to the other parties in a conference. In this manner there is little processing that is required for the packets. The server may permit and/or blocking of users based upon any criteria.

The conferencing interface device 22 also comprises a conferencing application program 30 that is typically stored in the device's mass storage. In a preferred embodiment, the conferencing application 30 is a Java® language-based program which runs in the operating system 32 of the conferencing interface device. The Java Runtime Environment 34, the software required to run a Java language application, initiates the conferencing application program and passes application specific arguments between the application program and the operating system. The conferencing application 30 initiates and configures a media framework 36, a program or programs that enable capture, playback, streaming and transcoding of data streams for audio, video and other time-based media. The media framework captures audio and video data from the audio 60 and the video capture devices 62 and encodes the data in formatted data packets for transmission over the computer network. In the preferred embodiment the media framework comprises the Java Media Framework (JMF) but other methods and protocols could be used to capture audio and video, encode, decode and render the audio and video content of a conference.

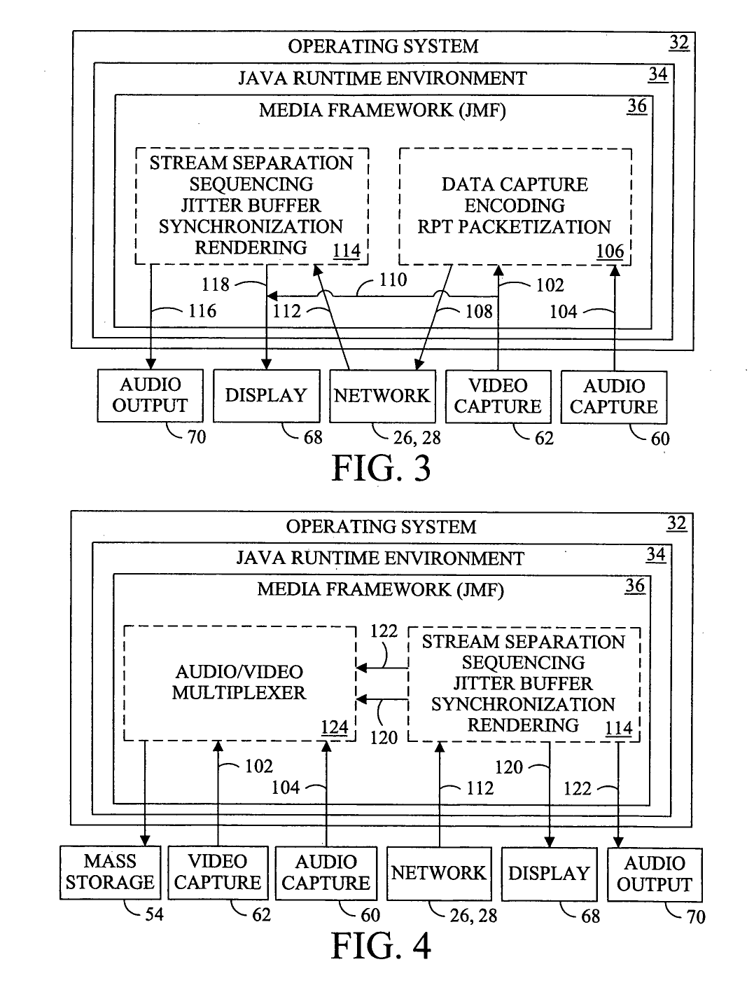

Referring to FIG. 3, the media framework 36, preferably the Java Media Framework (JMF), is a set of tools in the JAVA Runtime Environment 34 which works in conjunction with the operating system 32 of the conferencing interface device. JMF together with other JAVA language tools such as the SWING software tool; a library of controls, such as checkboxes, sliders and virtual buttons, for a graphical user interface; and the WEBSTART software tool, software that facilitates downloading and updating software from the worldwide web, enables encoding, recording and rendering audio and video data streams. Video and audio data is, respectively, captured by a video capture device 62 and an audio capture device 60. The captured video stream 102 is duplicated by the media framework and one copy of the video data stream and the audio data stream 104 are encoded and packetized 106 as RTP packets for transmission 108 over the communication network 26, 28 of the conferencing system. Another copy of the video stream 112, captured by the video capture device, is not packetized but is sent to the video display 68 of the conferencing interface device for local display on a graphical user interface of the conferencing system. A stream 112 (one or more actual streams) comprising audio and video data is separated into respective audio and video streams, sequenced and synchronized 114. The audio stream 116 and the video stream 118, combined with the locally captured video stream 110 are transmitted to the, respective, audio output device 70 and display 68 for rendering. The capture, encoding, and sending may be performed by platform specific binaries within the JMF, if desired. In many cases, the local video is played back to the local host while the local audio is not played back ot the local host to avoid echos. The video may be the source video because it appears better or be the “rendered” video that represents what others will observe. The source and rendered video may be user selectable.

The media framework preferably formats the data packets of the captured audio and video data streams according to the Real-Time Transport Protocol (RTP). RTP is an Internet protocol for transporting real-time data, including audio and video. RTP and RTCP provides end-to-end network transport functions; such as timing, reconstruction, loss detection, security and content identification, suitable for applications, such as audio and video, comprising real-time data transmitted over unicast or multicast communication networks. The data transport function is augmented by a control protocol (RTCP), that allows monitoring of data delivery in a manner scalable to large multicast networks. Unicast refers to a transmission from a single source to a single destination and multicast refers to a transmission from a single source to a subset of all destinations capable of receiving the transmission. The formatted data packets are forwarded to an RTP connector 38 for transmission by the conferencing interface device's communication facility. The RTP connector 38 also receives RTP formatted data from the network through the conferencing interface device's communication facility and forwards the data to the media framework where the stream is depacketized and decoded for rendering. The RTP formatted data received from the communications facility includes data generated by other users or conference participants, represented by conferencing interface devices 22b and 22c. Other transmission protocols for transmitting audio and/or video may likewise be used.

Referring to FIG. 4, the media framework also provides for recording of the audio and video content of a conference. The transport stream 112 from the communication network 26, 28 is separated into individual audio 122 and video 120 streams which are sequenced and synchronized 114. The resulting video and audio data streams are transmitted to the display 68 and the audio output device 70 for rendering and transmitting to an audio/video multiplexer 124. The multiplexer, which may also receive the local video capture 102 and audio capture 104 data streams combines the data streams and translates the data to a video file format, such as the QUICKTIME® video file format, which can be saved to mass storage 54 to record the conference.

The conferencing interface device 22 also preferably includes a messaging framework 40 for sending and receiving messages, defined by the conferencing application program 30, to and from other participants in a conference. The messaging framework, preferably, delivers messages to participants who are present in the conference but, because a conference is a dynamic, real-time activity, does not typically store messages. In the event of a late entry to the conference, the messaging framework of the late-arriving conferee's conferencing interface device transmits a message to the other participants in the conference notifying them of the new attending participant. A conference participant's receipt of a message indicating the entry of a new participant in the conference triggers a response identifying the recipient and describing the recipient's current status.

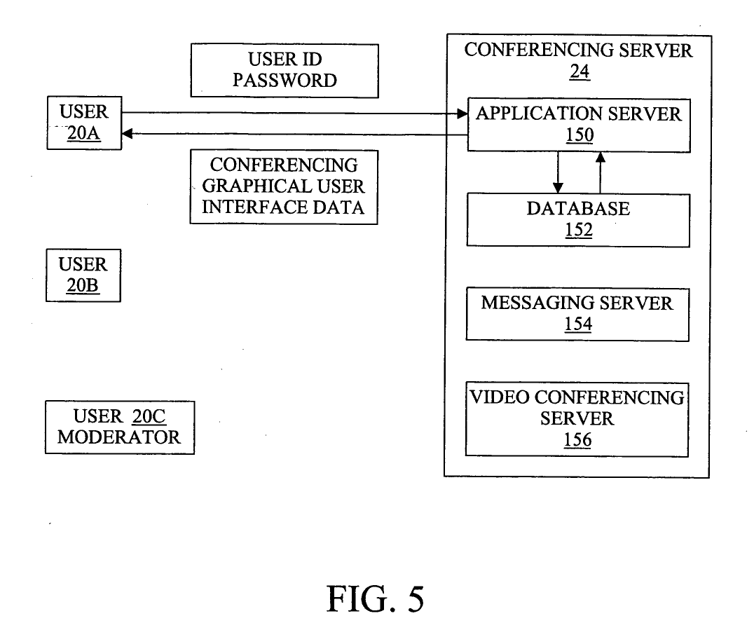

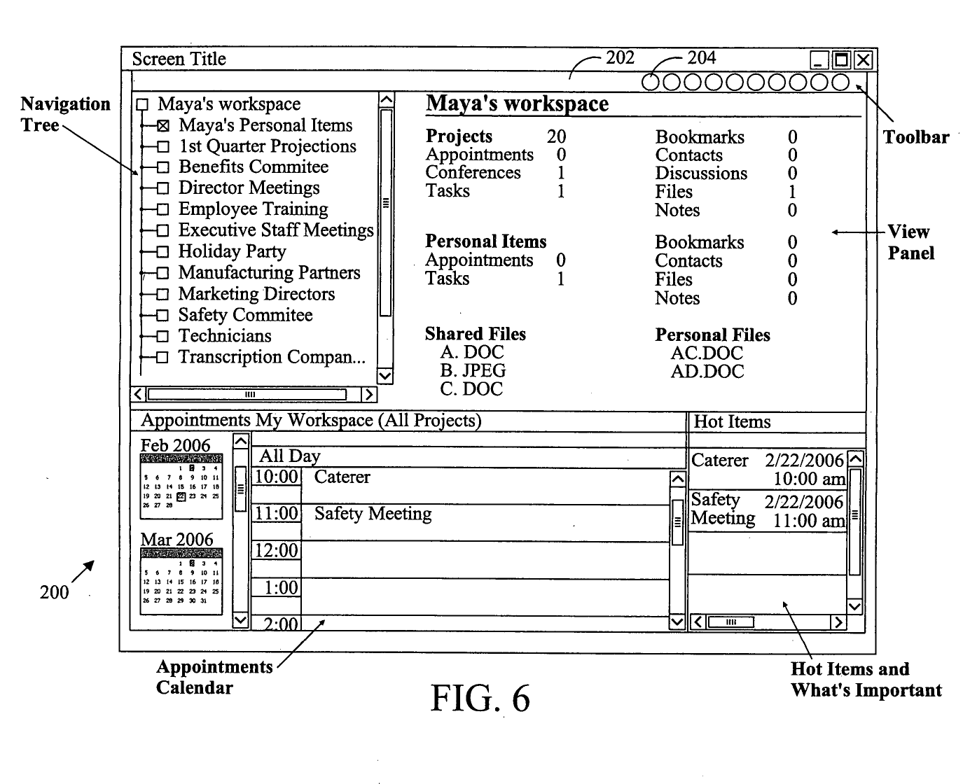

A user can access the conferencing system 20 by entering a user name and password on a portal web page that is displayable with a web browser program 42 on the user's conferencing interface device 22. Referring to FIG. 5, the user name and password are transmitted to the conferencing server 24 and, more specifically, an application server 150. The application server queries a conferencing database 152 to verify that the user name and password entered by the user are registered for the conferencing system. If the user name and password are included in the conferencing system database, the application server obtains user data; including, for examples, the user's name, team members and projects; from the database and returns the user data to the conferencing interface device. The services shown in FIG. 5 (24, 150, 152, 154, 156) may likewise reside on one or more separate machines distributed through the network. Referring to FIG. 6, utilizing the user data, the conferencing interface device renders a conferencing system graphical user interface (GUI) 200 on the display 68 of the interface device. The conferencing system graphical interface 200 enables a user to organize and schedule tasks, conferences and appointments related to projects with which the user is associated. The conferencing system graphical interface also includes a toolbar 202 comprising a plurality of virtual buttons 204 enabling the user to add, delete and otherwise change scheduled activities.

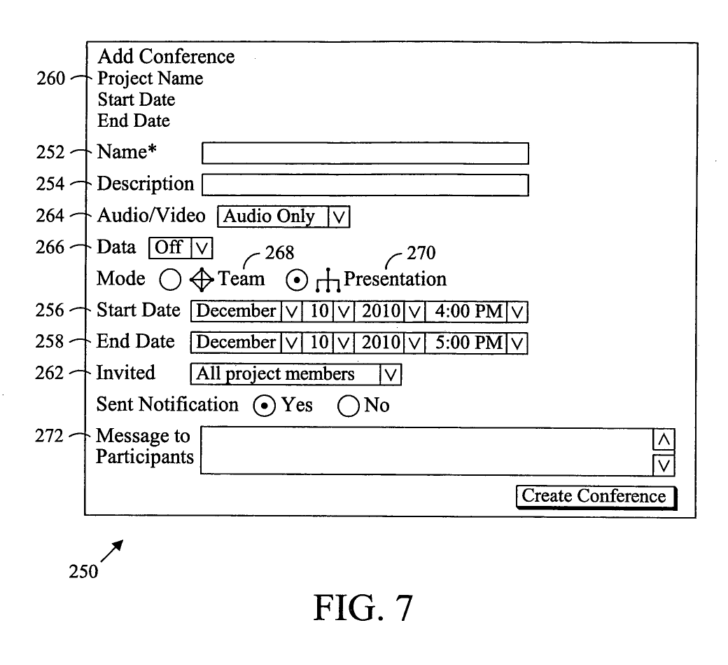

A user authorized to access the conferencing system can schedule a conference from the conferencing system graphical interface 200 displayed on the user's interface device. Referring to FIG. 7, by selecting one of the virtual buttons 204 of the toolbar 202 of the graphical interface 200, the user can cause the conferencing interface device to display an add-conference interface 250. The add-conference interface enables entry of a name 252 for a conference, a description of the conference 254, and the starting 256 and ending 258 times of the conference. The user can also associate the conference with the name of one of the projects with which the user is associated 260 and, using a drop down menu, invite all or some of the members of the project team 262. The user can also select whether the conference will utilize neither audio nor video, audio alone or both audio and video 264. Audio and video may not be necessary or desirable during a data sharing conference and, if bandwidth is limited at a conference location or if the number of conference locations is large, it may be necessary to confer by audio only. The conference scheduler can also select whether data sharing tools 266, such as file sharing and whiteboard, will be in use during the conference.

In addition, the add conference interface 250 enables the user scheduling a conference to select a mode for the conference. The conferencing system enables a team mode 268 in which all conference participants can simultaneously transmit and receive audio, video and data, to the extent that audio, video and data transmission is enabled for the conference. Since the team mode require transport streams containing audio, video and, in many cases, data from each of the conference locations, the number of locations from which participants can transmit is often limited by the bandwidth required for transmission of the multiple data streams. In the presentation mode 270, audio and video is transmitted primarily by a single individual while the remaining participants watch and listen. If permission is granted by the conference moderator, one or more of the other conferees may transmit audio and/or video. In addition, the user's may request permission from the moderator. The presentation mode limits the number of locations that are simultaneously transmitting and, commonly, limits transmission, from users other than the moderator, to audio. The bandwidth required for a conference in the presentation mode is typically less than the bandwidth required for the team mode allowing larger numbers of conference locations. When the presentation mode 270 is selected, the conferencing system designates the user scheduling the conference as the conference moderator. From the add-conference interface, the scheduler of the conference can designate who will be invited to the conference and send notification to the invitees with a message 272, if desired. When the conference's configuration has been specified by the scheduler of the conference, a conference configuration, including name, description, time and names of invitees, is transmitted to the application server and stored in the conferencing system database 152. The conferencing server transmits an invitation and any associated message to each of the conference invitees.

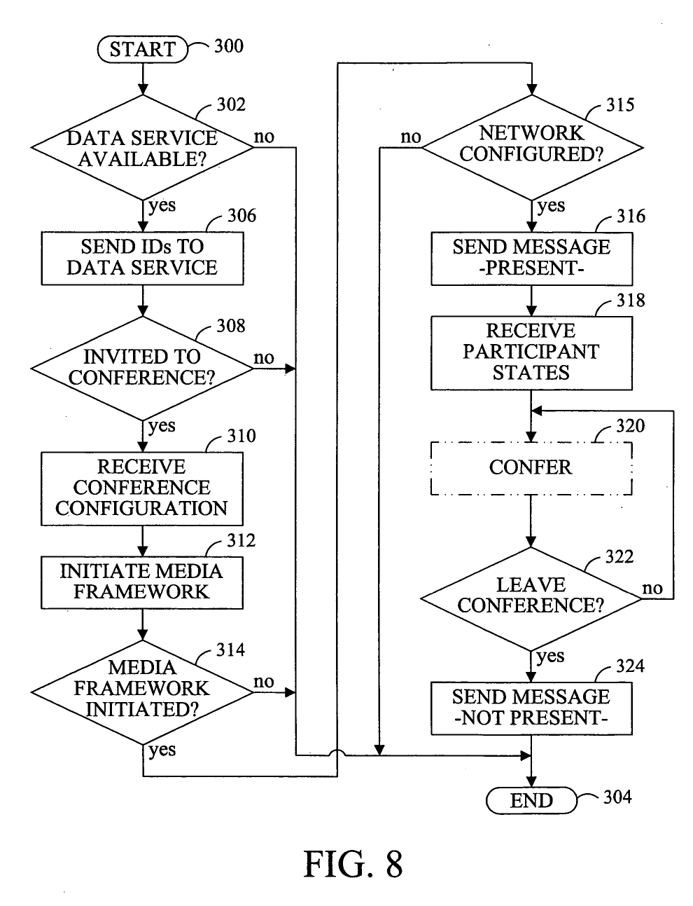

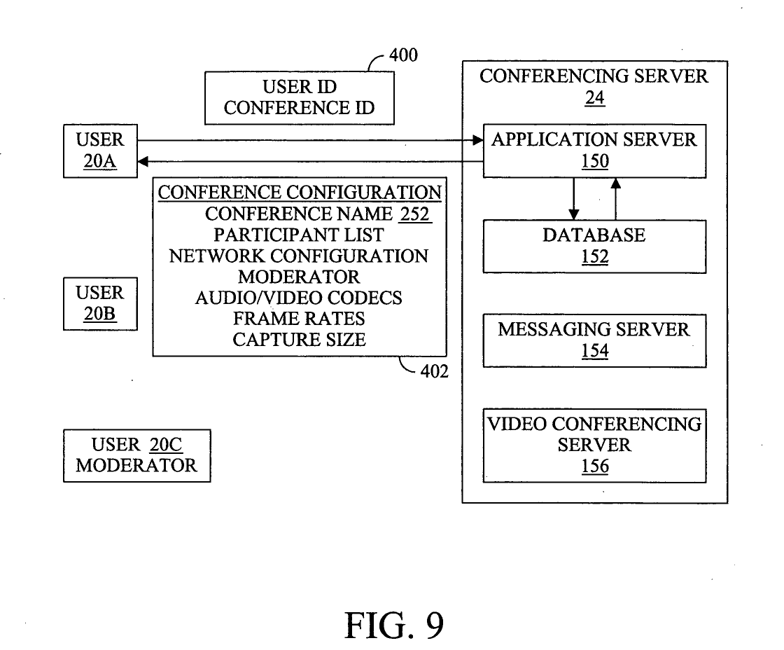

Referring to FIG. 8, to participate in a conference, the conferencing application is initiated 300 on a user's conferencing interface device, for example conferencing interface device 22a. The interface device connects to the conferencing server 24 and determines if data services, such as the messaging server 154, are available 302. If the data services are not available, the application exits 304. Referring to FIG. 9, if the data services are available, the user's identification, such as the user's username and password, and a conference identifier 400 are transmitted by user's conferencing interface device to the conferencing server and more specifically to the application server 306. The application server checks the database and determines if the user is invited to the conference 308. If the application server does not confirm the user's invitation to the conference, the conferencing application exits 304. If the identified user is a conference invitee 308, the application server transmits conference configuration data 402, stored in the conferencing system database 152, to the user's conferencing interface device. The conference interface device utilizes the conference configuration data; comprising the conference name 252, participant list, communication network configuration, moderator identity, audio and/or video coder and decoder identification; received from the conferencing server 310 to configure the relevant systems of interface device to enable entering and participating in the conference.

In response to receiving the conference configuration data, the conferencing application initiates the media framework 314 which attempts to enable the respective devices and systems of the interface device, as required by the conference configuration, to capture, transmit, receive and render conference video, audio, and data. For example, a participant should be able to receive and render audio and the moderator of a conference should be, at least, able to capture and transmit audio. If the media framework cannot be initiated or any required medium capture or rendering device enabled, the conferencing application exits 304.

If the required data capture and rendering systems are successfully enabled, the conferencing application attempts to configure any required network resources 315. For example, the conferencing application attempts to contact the messaging server 156, join conference multicast groups or establish a socket connection to any video conferencing servers required by an RTP connector. To participate in a conference (such as Unicast) comprising audio and video, the conferencing interface device preferably creates four TCP (Transmission Control Protocol) sockets for communication between the user interface device and the video conferencing server 156. Also, the system could use a single socket for each stream, two sockets for each stream, UDP, or any other arrangement. The TCP sockets, comprising an Internet Protocol address and a port number, are endpoints for communications between the server and the user interface device. A TCP socket is established for each of video RTP communication, video RTCP communication, audio RTP communication and audio RTCP communication. The RTCP sockets enable communication of control information associated with transmission and reception of RTP data packets. RTCP provides for counting lost packets, measuring jitter and other housekeeping duties defined by the RTP protocol. If the conferencing application cannot configure the required network resources, the conferencing application exits 304.

If the required network resources are successfully configured a PRESENT message is transmitted to all conference participants 316 and the user, represented by the conferencing interface device 20a, enters the conference. The PRESENT message is transmitted to the messaging server 154 by the messaging framework 40 of conferencing interface device. Preferably, the messages transmitted and received by the messaging framework are propagated using Jabber communication protocols. Jabber is an open XML (Extensible Markup Language) protocol for instant messaging. In response to receipt of the PRESENT message from the newly entering conferencing interface device, the messaging server 154 transmits the PRESENT message to all of the previously entered participants in the conference and transmits presence status for the list of current participants to the newly entering conferencing interface device. The messaging framework of the newly entering conferencing interface device transmits a message to all of the current participants in the conference requesting that the participants acknowledge the newly entering participant by transmitting current status data for the respective participant. The system may likewise provide application specific status, such as for example, transmitting, requesting, receiving, and sleeping (idle) for audio, video, and/or text.

Preferably, each participating conferencing interface device maintains its own state data, specifying; for examples, without limiting possible state data, the current conference identification, whether the conferencing interface device is the moderator of a presentation conference, whether the conferencing interface device has permission to transmit audio, and whether the conferencing interface device is transmitting video. When a participant receives a message from the messaging server, the respective user interface device responds by transmitting its current state data to the newly entered participant and, if required by the conference mode, configures itself to receive an additional data stream from the new conference participant. During the conference, the state data of the respective participants may change, for example, permission to transmit audio may be granted to a conferencing interface device participating in a presentation type of conference or a conference participant may leave the conference. As required, the messaging server 154 transmits messages to the messaging framework of each current participant advising the participant of a change in the status of another participant.

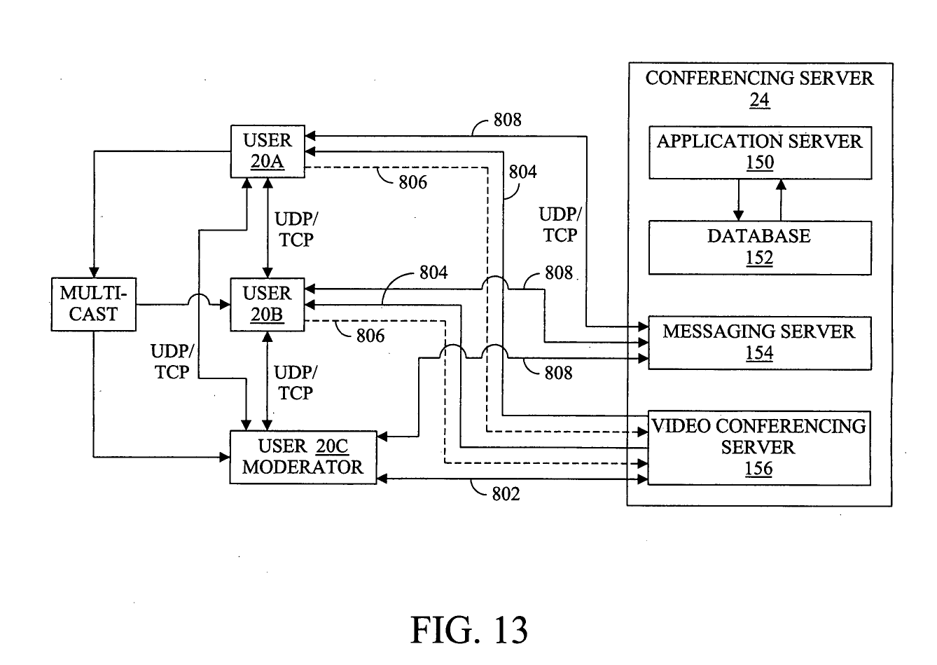

Once the information regarding the conference participants has been received 318, the conferencing interface device begins rendering the conference's audio and video streams 320. Referring to FIG. 13, when the TCP sockets are established, the conferencing interface device will be able to transmit and receive video and audio through the video conferencing server 156. In the presentation mode, the moderator 20c can transmit and receive video and audio 802 to the video conferencing server 156 while the other participants are limited to receiving audio and video 804 from the video conferencing server. If a participant, other than the moderator, wishes to transmit, the participant may request permission from the moderator and transmission is usually limited to audio 806. The video conferencing server 156 is typically capable of handling a plurality of independent conferences each with multiple participants. All participants can transmit messages to and receive messages from the messaging server 808. The conferee continues to participate in the conference until the user elects to leave the conference or the conference ends 322. If the user leaves the conference or the conference ends, a NOT PRESENT message is transmitted 324 by the messaging framework of the conferencing interface device and the conferencing application terminates 304. In some cases, if the moderator exits the conference, then all transmission in the conference terminates.

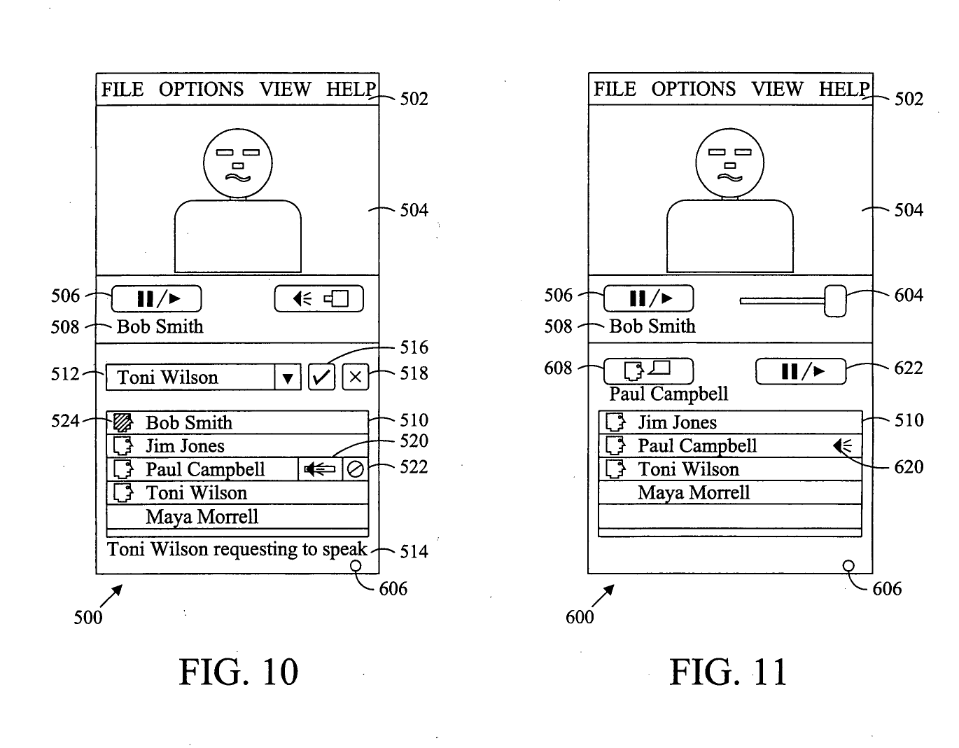

In the presentation mode, the conference host and moderator is the presenter and the other participants are generally passive listeners and viewers of the host's audio or video and audio presentation. Referring to FIGS. 10 and 11, respectively, during a presentation mode conference, the conferencing interface device of the conference moderator displays a moderator's conference console 500 and the conferencing interface device(s) of other conference participants display a conferee conference console 600. The conference consoles 500, 600 present menu options from a menu bar 502, including drop down menus enabling the moderator to start and stop transmission and record the conference. The moderator or another conference participant may also view conference information, participant properties and reception statistics through drop down menus rendered in response to selection of one of the choices on the menu bar.

Video of the moderator is displayed in a viewing pane 504 during a presentation mode conference. Conference participants can toggle the video display of the moderator on or off by selecting and actuating a video toggle button 506 below the viewing pane. If the conference does not include video, no image is displayed in the viewing pane or no pane is displayed. The name of the presentation mode conference moderator 508 is displayed below the viewing pane with an audio volume slider 604 permitting the user to adjust the volume of the moderator's audio transmission. The moderator may initiate recording of the conference from a drop down menu in the menu bar and, in some embodiments of the conferencing system, other participants may also record the conference. A recording indicator 606 on the conferee conference console changes state to indicate when the conference is being recorded. In addition, all users may be provided with a recording indicator.

The names of the invitees to the conference are displayed in a participant panel 510 below the viewing pane. An invitee's presence in the conference is indicated by an icon 524 which is displayed proximate the invitee's name when the participant enters the conference.

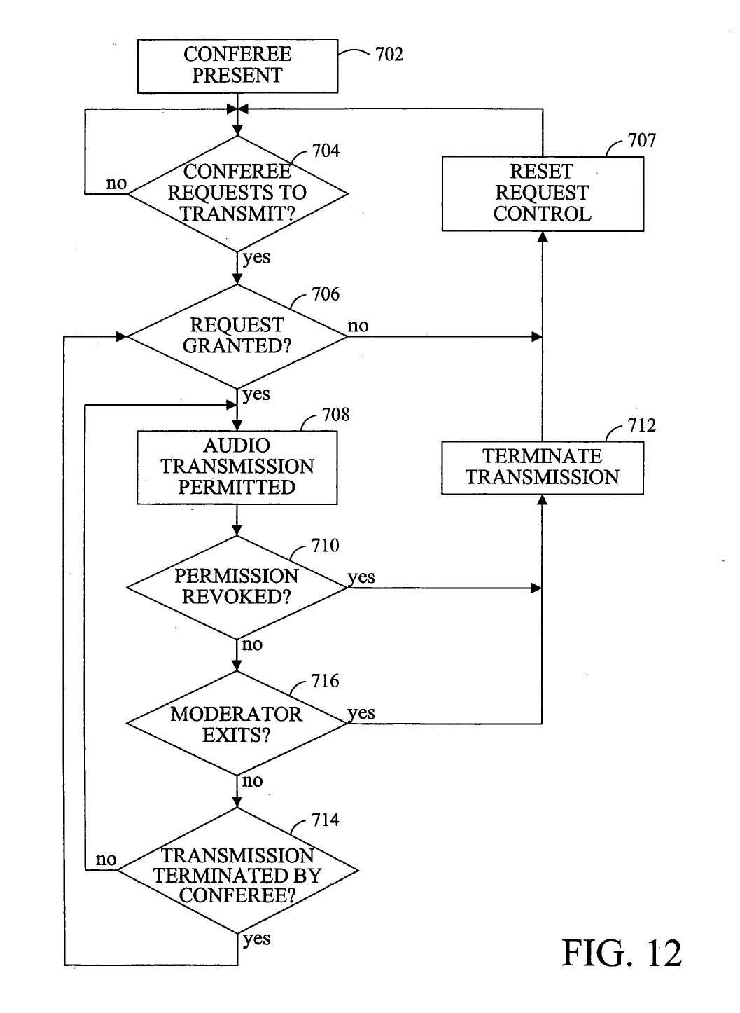

Referring also to FIG. 12, in the presentation mode the conference participants are commonly passive, listening to the audio and, if applicable, viewing the video of the presenter. However, a conferee, other than the moderator, may wish to speak, for example to seek clarification of the presentation or present additional material. The conferencing system enables controlled participation by all conferees by enabling conferees to transmit audio when granted permission by the conference moderator. When a conferee, other than the moderator, enters a presentation conference, the conferee's state is that of a passive listener and viewer 702. If the conferee wishes to address the other participants, the conferee can request permission to transmit audio 704 by selecting and actuating a request control button 608 on the conferee conference console 600 using a pointing device of the conferencing interface device. When the user selects the virtual request control button 704, the name of the participant requesting permission is displayed on the moderator's conference console 512 and the participant's name and request are displayed on a status bar 514. The moderator can grant or deny the requester permission to speak by selecting, respectively, a permission granted control button 516 or a permission denied control button 518 displayed on the moderator's control console 500. If permission to transmit is denied 706, the conferencing application resets the permission request control button 707, enabling the participant to again request permission to transmit, and the participant continues to passively participate. If the request to transmit is granted by the moderator 706, transmission is enabled for the participant having permission 708 and an audio permitted icon 520, 620 is displayed proximate the participant's name in participant name pane on the respective control panels 500, 600. To begin audio transmission, the user, preferably, toggles the audio transmission control button 622 on the conferee conference control panel and begins speaking. However, transmission may be enabled so that transmission begins when the user having permission begins speaking. Video and audio of the conference moderator can continue simultaneously with the audio from one or more permitted conference participants.

Audio transmission is enabled 708 for the conferee having permission to transmit until the permission is either terminated by the moderator 710 or by the conferee having permission 714 to terminate or by the moderator exiting 716. Audio transmission by a participant having permission to transmit can be toggled on or off by a transmission control button 622 on the participant's conference console 600. In addition, the moderator can revoke the permission to transmit by selecting a permission revocation control 522 displayed on the control panel proximate the name of a conferee having permission to transmit. If permission is revoked by the moderator 710, audio transmission by the conferee is terminated 712 and the conferencing application resets the permission request control 707 and returns the participant to the passive listening and viewing state. Likewise, if the conferee with permission terminates audio transmission 714 by toggling the transmission control 622 or otherwise, transmission is terminated 714 the user may transmit again when desired. An icon 620 proximate the name of the conferee indicates that the conferee has permission to transmit even though the conferee may not be speaking.

The conferencing system enables management of communication between a large number of remotely located conference participants and improves the participant's satisfaction with computer based conferencing.

The conferencing system may also use the same techniques, alone or in combination, to provide a moderated desktop of a computer (desktop or server). In this manner, items on the desktop may be shared in a controlled manner.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A method of managing communication between participants in a conference, said method comprising the steps of:
(a) designating a first conferencing interface device operated by a first participant as a moderator of said conference;
(b) transmitting a request from a second conferencing interface device operated by a second participant to said first conferencing interface device, said request seeking permission to transmit at least one of audio, video and textual data;
(c) transmitting a responding response from said first conferencing interface device to said second conferencing interface device, said responding response comprising one of a first responding response permitting transmission by said second conferencing interface device and a second responding response denying said second conferencing interface device permission to transmit said data, and
(d) in the event that said responding response from said first conferencing interface device permits transmission, transmitting said data by second conferencing interface device.

2. The method of managing communication between conference participants of claim 1 wherein the step of transmitting a responding response from said first conferencing interface device to said second conferencing interface device further comprises the step of selecting one of said first and said second responding responses in response to a control input to said first conferencing interface device by said first participant.

3. The method of managing communication between conference participants of claim 1 further comprising the step of displaying an indicia of said responding response on a display of said second conferencing interface device.

4. The method of managing communication between conference participants of claim 1 further comprising the step of transmitting said responding response to a third conferencing interface device operated by a third conference participant.

5. The method of managing communication between conference participants of claim 1 further comprising the step of displaying an indicia of said responding response on a display of said third conferencing interface device.

6. The method of managing communication between conference participants of claim 1 further comprising the step of transmitting a response from said first conferencing interface device to said second conferencing interface device revoking a prior permission for data transmission by said second conferencing interface device.

7. The method of managing communication between conference participants of claim 1 wherein at least one of the step of transmitting said request and the step of transmitting said responding response comprises a transmission to, respectively, said first conferencing interface device and said second conferencing interface device.

8. A method of managing communication between participants in a conference, said method comprising the steps of:
(a) arranging a conference including selecting a conference mode enabling transmission of at least one of audio, video, textual and message data by a first conferencing interface device operated by a first participant in said conference and designating at least one other prospective participant in said conference;
(b) transmitting a response inviting said other prospective participant to participate in said conference;
(c) enabling entry of said first conferencing interface device to said conference, said entry of said first conferencing interface device enabling transmission of at least one of audio, video, textual and message data by a first conferencing interface device;
(d) enabling entry to said conference of a second conferencing interface device operated by said other prospective participant, said entry enabling said second conferencing interface device to receive audio, video, textual and message data transmitted by said first conferencing interface device and enabling transmission of message data by said second conferencing interface device;
(e) transmitting a message from said second conferencing interface device to said first conferencing interface device, said message seeking permission to transmit at least one of audio, video and textual data;
(f) transmitting a responding message from said first conferencing interface device to said second conferencing interface device, said responding message comprising one of a first responding response permitting transmission by said second conferencing interface device and a second responding response denying said second conferencing interface device permission to transmit said data, and
(g) in the event that said responding response from said first conferencing interface device permits transmission, transmitting said data by second conferencing interface device.

9. The method of managing communication between conference participants of claim 8 wherein the step of transmitting a responding message from said first conferencing interface device to said second conferencing interface device further comprises the step of selecting one of said first and said second responding responses in response to a control input to said first conferencing interface device by said first participant.

10. The method of managing communication between conference participants of claim 8 further comprising the step of displaying an indicia of said responding message on a display of said second conferencing interface device.

11. The method of managing communication between conference participants of claim 8 further comprising the step of transmitting said responding message to a third conferencing interface device operated by a third conference participant.

12. The method of managing communication between conference participants of claim 8 further comprising the step of displaying an indicia of said responding message on a display of said third conferencing interface device.

13. The method of managing communication between conference participants of claim 8 further comprising the step of transmitting a message from said first conferencing interface device to said second conferencing interface device revoking a prior permission for data transmission by said second conferencing interface device.

14. The method of managing communication between conference participants of claim 8 wherein at least one of the step of transmitting a message seeking permission to transmit data and the step of transmitting a responding message comprises a unicast transmission to, respectively, said first conferencing interface device and said second conferencing interface device.

15. A conferencing system comprising:
(a) a first conferencing interface device comprising:
(i) a processing unit performing an operation on data according to an instruction;
(ii) a media framework interconnected to said processing unit and including an instruction enabling capturing and rendering of at least one of a video and an audio;
(iii) a messaging framework interconnected to said processing unit and enabling selection by said processing unit and transmission of a message requesting permission to transmit at least one of audio, video and textual data to at least one other conferencing interface device and signaling said processing unit of receipt of a responding response granting said permission to transmit one of said audio, video and textual data; and
(iv) a communication facility communicatively interconnecting said first conferencing interface device and a second conferencing interface device, enabling reception of audio, video, textual and message data from said second conferencing interface device and transmitting one of said audio, video, textual and message data in response to a signal from said processing unit that permission to transmit has been granted; and
(b) a second conferencing interface device comprising:
(i) a processing unit performing an operation on data according to an instruction;
(ii) a media framework interconnected to said processing unit and including an instruction enabling capturing and rendering of at least one of a video and an audio;
(iii) a messaging framework interconnected to said processing unit and enabling selection by said processing unit of one of a first responding response and a second responding response and transmission of said selected responding response, said first responding response granting permission to transmit at least one of audio, video and textual data and said second responding response denying said permission to transmit said data; and
(iv) a communication facility enabling transmission of at least one of audio, video, textual and message data to said first conferencing interface device and reception of at least one of audio, video, textual and message data from said first conferencing interface device.

16. The conferencing system of claim 15 wherein said second conferencing interface device includes a control operable by a conference participant to signal said processing unit to transmit one of said first and said second responding responses.

17. The conferencing system of claim 16 wherein said control operable by said conference participant to signal said processing unit to transmit one of said first and said second responding responses comprises a graphic rendered on a display of said second conferencing interface device and selectable with a pointing device.

18. The conferencing system of claim 15 further comprising a graphic rendered on a display of said first interface device indicating receipt of first responding response and, alternatively, indicating receipt of said second responding response.

19. The conferencing system of claim 15 further comprising a third conferencing interface device comprising:
(a) a processing unit performing an operation on data according to an instruction;
(b) a media framework interconnected to said processing unit and including an instruction enabling capturing and rendering of at least one of a video and an audio;
(c) a messaging framework interconnected to said processing unit and signaling said processing unit of receipt of a response granting and, in the alternative, denying permission to said first conferencing interface unit transmit one of said audio, video and textual data; and
(d) a communication facility communicatively interconnecting said third conferencing interface device and a second conferencing interface device, enabling reception of audio, video, textual and message data from said second conferencing interface device.

20. The conferencing system of claim 19 wherein said third conferencing interface device further comprising a graphic rendered on a display of said third conferencing interface device indicating transmission of said first responding response to said first conferencing interface device.

21. The conferencing system of claim 19 further comprising a server communicatively interconnected to said first conferencing interface device, said second conferencing interface device and said third conferencing interface device, said server receiving at least one of said audio, video and textural data from said second conferencing interface device and retransmitting said data to an address accessible by said first and said third conferencing interface devices and receiving message data from said second conferencing interface device and retransmitting said message data to an address accessible by said first conferencing interface device and to another address accessible by said third conferencing interface device.

22. A conferencing system comprising:
(a) a first conferencing interface device capable of transmitting message data requesting permission to transmit at least one of audio, video and textual data and capable of receiving message data comprising one of a first response permitting transmission of at least one of audio, video and textual data and a second responding response deny permission to transmit said audio, video and textual data; and
(b) a second conferencing interface device communicatively interconnected to said first conferencing interface device and capable of transmitting at least one of audio data, video data, textual data and message data to said first conferencing interface device, said second conferencing interface device transmitting one of said first and said second responding responses to said first conferencing interface device in response to receipt of message data from said first conferencing interface device requesting permission to transmit and actuation of a control by a user of said second conferencing interface device selecting one of said first and said second responding responses for transmission.

23. A method of operating a conferencing system comprising the steps of:
(a) designating one of a plurality of conference participants as a conference moderator; and
(b) enabling said moderator to selectively allow and disallow other participants to transmit at least one of audio and video.

24. The method of operating a conferencing system of claim 23 further comprising the step of enabling said moderator to transmit at least one of audio and video while another participant is transmitted at least one of audio and video.
